(19) United States
(12) Patent Application Publication
(10) Pub. No.: US 2003/0106921 A1
(43) Pub. Date: Jun. 12, 2003

(54) Tearing tool

(76) Inventors: Kevin J. Urlaub, Boise, ID (US); Daiquiri Rose Fouch, Boise, ID (US); Frederic Adam Ornellas, Boise, ID (US); Eric L. Ames, Boise, ID (US)

Correspondence Address: HEWLETT-PACKARD COMPANY, Intellectual Property Administration, P.O. Box 272400, Fort Collins, CO, 80527-2400, US

(21) Appl. No.: 10/007,919

(22) Filed: Dec. 7, 2001

(51) Int. Cl. B26F 3/02

(52) U.S. Cl. 225/4; 225/103

(57) ABSTRACT

A tool is provided that has a grasper adapted to selectively grasp a tearable medium, a conveyer adapted to selectively move the grasper along an axis to move the tearable medium against a tear-off edge to sever the tearable medium, and a controller adapted to transmit a first signal for instructing the conveyer to move the grasper and a second signal for instructing the grasper to grasp the tearable medium.

### TECHNICAL FIELD

The present invention relates generally to the field of tools and, in particular, to an automated tearing tool.

### BACKGROUND

Many printers, e.g., receipt printers, print data images on a paper tape. The paper tape advances from the printer as the data images, e.g., in form of a receipt, are printed. The paper tape stops advancing when printing is completed. One common type of printer includes a roll of paper tape that unrolls during printing. After the paper stops, an individual, e.g., a sales clerk, tears off a segment of the paper tape bearing the printed images, e.g., a receipt, by pulling the tape against a tear-off edge that forms a part of the printer.

As segments of the paper tape are repeatedly torn off, the tear-off edge begins to wear, and eventually the tear-off edge fails to tear the paper tape. Therefore, it is often desirable to relate the number of segments of the paper tape torn off to the wear of the tear-off edge. This typically involves an individual tearing each of a large number of segments off by hand. One problem with hand tearing the segments is that hand tearing is costly in that hand tearing involves many hours that can conceivably be spent doing other tasks perceived as being more productive.

Some of these printers use ink-jet cartridges to deposit data images on the paper tape. Ink-jet cartridges typically have a number of flow passages for producing a number of ink jets. As each segment of the paper tape is torn off, paper particles are given off. In many instances, a portion of these particles lodge in one or more of the flow passages, clogging the passage(s). Therefore, it is often desirable to obtain information about the paper particle sizes and shapes generated from tearing segments of paper tapes of various compositions. This again typically involves an individual tearing each of a large number of segments off by hand and includes the above-mentioned problems associated with hand tearing.

For the reasons stated above, and for other reasons stated below which will become apparent to those skilled in the art upon reading and understanding the present specification, there is a need in the art for an automated tearing tool.

### SUMMARY

The above-mentioned problems with hand tearing and other problems are addressed by embodiments of the present invention and will be understood by reading and studying the following specification. Embodiments of the present invention provide tearing tools for automatically tearing a tearable medium, e.g., paper tape. The tearing tools provided facilitate a reduction in cost associated with testing for printer tear-off edge wear and generation of particles of the tearable medium caused by tearing the tearable medium at the tear-off edge by eliminating hand tearing of the tearable medium during testing.

More particularly, in one embodiment, a tool is provided that has a grasper adapted to selectively grasp a tearable medium, a conveyer adapted to selectively move the grasper along an axis to move the tearable medium against a tear-off edge to sever the tearable medium, and a controller adapted to transmit a first signal for instructing the conveyer to move the grasper and a second signal for instructing the grasper to grasp the tearable medium.

Other embodiments are described and claimed.

### BRIEF DESCRIPTION OF THE DRAWINGS

FIG. 1 is an overall view showing an embodiment of a tool positioned adjacent a printer according to the teachings of the present invention.

FIG. 2 is an overall view showing the tool of FIG. 1 receiving a paper tape from the printer of FIG. 1 according to the teachings of the present invention.

FIG. 3 is an overall view showing the tool of FIG. 1 grasping a segment of the paper tape of FIG. 2 after the paper tape is severed according to the teachings of the present invention.

FIG. 4 is an overall view showing the tool of FIG. 1 after releasing the segment of paper tape of FIG. 3 according to the teachings of the present invention.

FIG. 5 is an enlarged view of an embodiment of a grasper of the tool of FIG. 1.

FIG. 6 is a side view showing the grasper of FIG. 5 grasping the paper tape according to the teachings of the present invention.

FIG. 7 is a side view showing the grasper of FIG. 5 receiving the paper tape according to the teachings of the present invention.

FIG. 8 is a block diagram showing embodiments of electrical and fluid circuitry according to the teachings of the present invention.

FIG. 9 is an enlarged view of an embodiment of a conveyer of the tool of FIG. 1.

### DETAILED DESCRIPTION

In the following detailed description, reference is made to the accompanying drawings that form a part hereof, and in which is shown by way of illustration specific illustrative embodiments in which the invention may be practiced. These embodiments are described in sufficient detail to enable those skilled in the art to practice the invention, and it is to be understood that other embodiments may be utilized and that logical, mechanical and electrical changes may be made without departing from the spirit and scope of the present invention. The following detailed description is, therefore, not to be taken in a limiting sense.

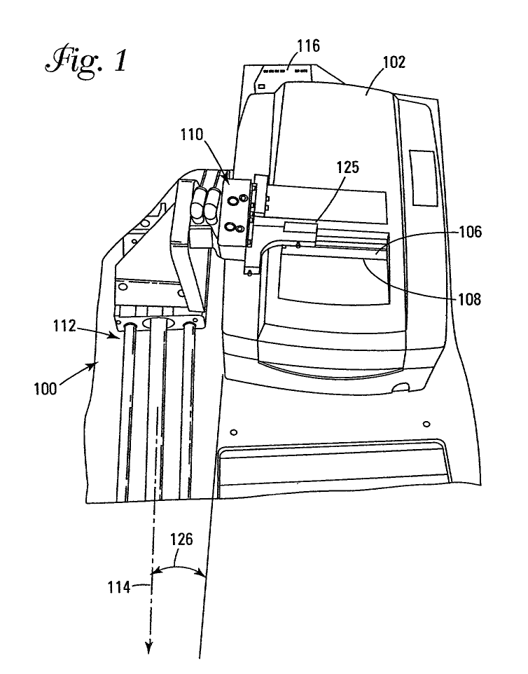

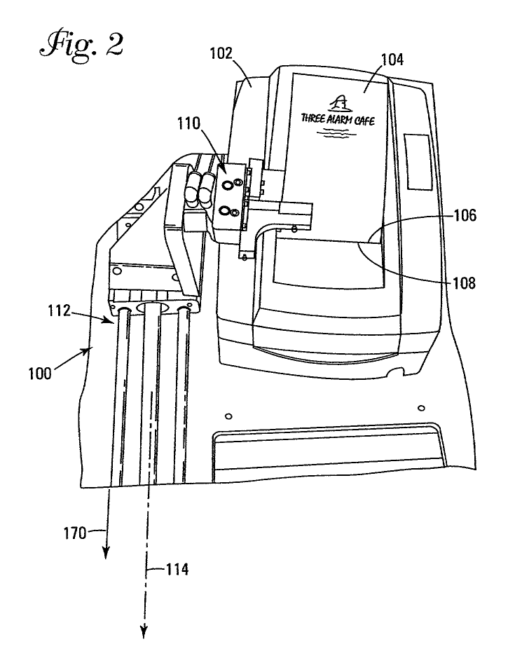

FIGS. 1-9 show various embodiments of aspects of a tool 100 according to the teachings of the present invention. Tool 100 is positioned adjacent a printer 102 (e.g., the POSIJET 1000 manufactured by Ithaca TransAct Technologies, Ithaca, N.Y., USA), as shown in FIGS. 1-4. Printer 102 deposits data images on a tearable medium, such as paper tape 104 (shown in FIG. 2), e.g., the type on which receipts are printed. As data is printed on paper tape 104, paper tape 104 advances and passes through a slot 106 in printer 102. Printer 102 includes a tear-off edge 108 over which paper tape 104 is severed after a desired amount of data has been printed on paper tape 104.

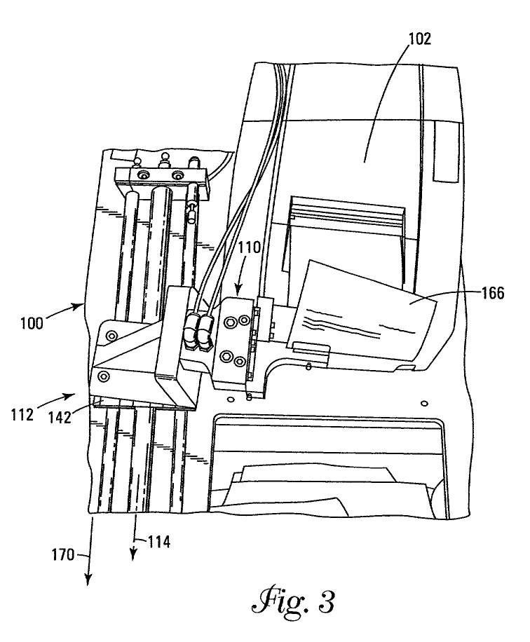

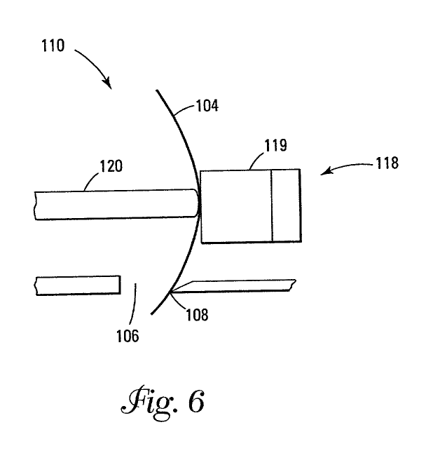

Tool 100 includes a grasper 110 adapted to selectively grasp paper tape 104, as shown in FIGS. 3 and 6. A conveyer 112, such as the NCDYS15H-0800b available from SMC Corporation, Tokyo, Japan, is attached to grasper 110. Conveyer 112 is adapted to selectively move grasper 110 along an axis 114 to move paper tape 104 against tear-off edge 108 to sever paper tape 104, as shown in FIG. 6. A controller 116, such as a programmable logic device (e.g., the KV-10R available from Keyence Corporation, Osaka, Japan), is adapted to transmit a first signal for instructing conveyer 112 to move grasper 110 and to transmit a second signal for instructing grasper 110 to grasp paper tape 104.

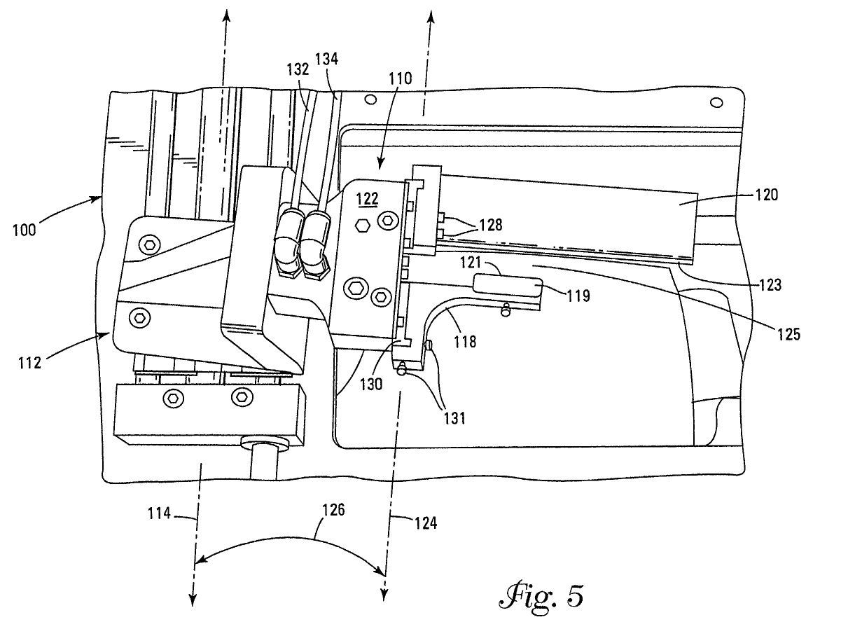

FIG. 5 is an enlarged view of grasper 110. Grasper 110 includes jaws 118 and 120 adapted to grasp paper tape 104 therebetween, as shown in FIGS. 3 and 6. Jaw 118 includes a pad 119 for frictionally engaging paper tape 104 along a surface 121 of pad 119. In one embodiment, pad 119 is fabricated from polyurethane, rubber, or the like. When jaws 118 and 120 grasp paper tape 108, jaw 120 engages paper tape 108 along a surface 123 of jaw 120. Jaws 118 and 120 are oriented so that their respective surfaces 121 and 123 are approximately parallel to tear-off edge 108. Therefore, when jaws 118 and 120 are open, a space 125, shown in FIGS. 1, 5, and 7, that separates jaws 118 and 120 is approximately parallel with slot 106 of printer 102. In one embodiment, each of jaws 118 and 120 are fabricated from metal, such as aluminum, steel, or the like.

Grasper 110 also includes an actuator 122 (e.g., Parallel Gripper RP-50P available from Robohand, Inc., Monroe, Conn., USA) for moving jaw 118 along an axis 124 that is approximately perpendicular to tear-off edge 108. Therefore, actuator 122 moves jaw 118 approximately perpendicularly to tear-off edge 108. Printer 102 is positioned at an angle 126 relative to axis 114, as shown in FIG. 1, where angle 126 ranges from approximately zero to ten degrees. In one embodiment, angle 126 ranges from approximately four to seven degrees. Actuator 122 moves jaw 118 into engagement with paper tape 104 to grasp paper tape 104 between jaws 118 and 120 and out of engagement with paper tape 104 for releasing paper tape 104 from between jaws 118 and 120. In one embodiment, screws 128, or the like, attach jaw 120 approximately perpendicularly to actuator 122 so that jaw 120 cannot move relative to actuator 122, and screws 131, or the like, secure jaw 118 to a slide 130 of actuator 122. FIG. 5 shows that slide 130 of actuator 122 is oriented at angle 126 with respect to the conveyer; that is, slide 130 moves along axis 124, which forms angle 126 with axis 114.

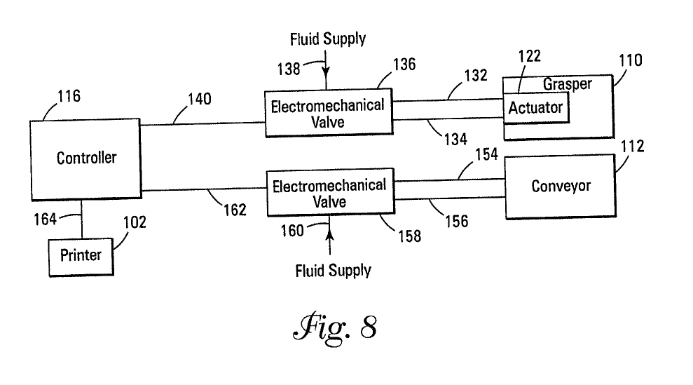

A fluid, such as air, supplied to actuator 122 by fluid-flow lines 132 and 134 causes slide 130 to move jaw 118 along axis 124. As best illustrated by the block diagram of FIG. 8, fluid-flow lines 132 and 134 are connected to an electromechanical valve 136, such as a solenoid valve (e.g., the NVJ5140 available from SMC Corporation, Tokyo, Japan), that is connected to a fluid supply by a fluid-flow line 138. Controller 116 is electrically connected to electromechanical valve 136 by a cable 140.

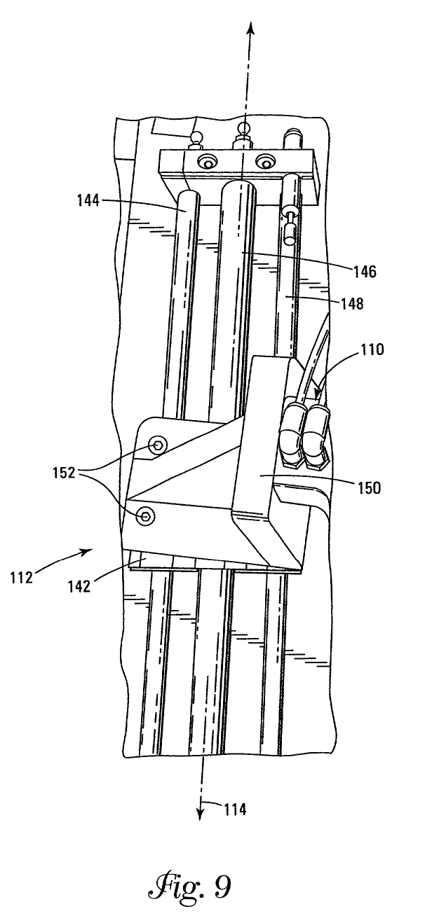

FIG. 9 is an enlarged view of conveyer 112. Conveyer 112 includes a carriage 142 that slides on rails 144, 146, and 148. A bracket 150, secured to carriage 142 by screws 152 or the like, attaches grasper 110 to carriage 142. A fluid, such as air, supplied to conveyer 112 by fluid-flow lines 156 and 158, as shown in FIG. 8, causes carriage 142 to slide on rails 144, 146, and 148, thereby moving grasper 110 along axis 114. FIG. 8 also shows that fluid-flow lines 154 and 156 are connected to an electromechanical valve 158, such as a solenoid valve (e.g., the NVJ5140 available from SMC Corporation, Tokyo, Japan), that is connected to a fluid supply by a fluid-flow line 160. Controller 116 is electrically connected to electromechanical valve 158 by a cable 162. Controller 116 is electrically connected to printer 102 by a cable 164.

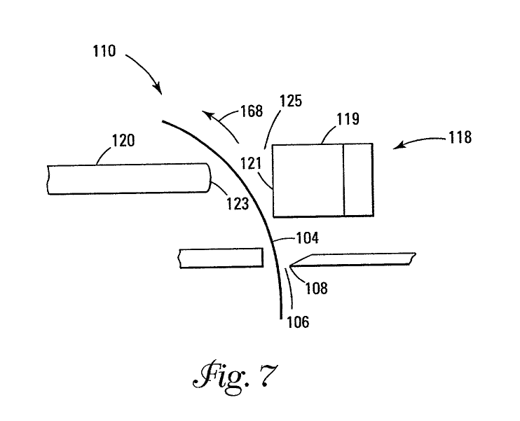

In operation, jaws 118 and 120 are initially open and are located above slot 106 of printer 102 in the position shown in FIG. 1. As printer 102 prints data on paper tape 104, paper tape 104 issues from slot 106 and passes through the space 125 between jaws 118 and 120 generally in the direction of arrow 168, as shown in FIG. 7. After a desired amount of data has been printed on paper tape 104, printer 102 sends a signal p1 (e.g., an “open cash drawer signal”) to controller 116 via cable 162.

Upon receiving signal p1, controller 116 respectively transmits each of a sequence of signals c at each of a sequence of times t preprogrammed into controller 116. At a time t1 of the timing sequence, controller 116 transmits a signal c1 to electromechanical valve 158 via cable 164 instructing electromechanical valve 158 to allow fluid to flow from the fluid supply to conveyer 112 via fluid-flow line 160, electromechanical valve 158, and fluid-flow line 154. This causes carriage 142 of conveyer 112 to slide on rails 144, 146, and 148 to move grasper 110 along axis 114 in the direction of arrow 170 in FIG. 2.

At a time t2 of the timing sequence, controller 116 transmits a signal c2 to electromechanical valve 136 via cable 140 instructing electromechanical valve 136 to allow fluid to flow from the fluid supply to actuator 122 via fluid-flow line 138, electromechanical valve 136, and fluid-flow line 132. This causes slide 130 of actuator 122 to move jaw 118 along axis 124 and into engagement with paper tape 104 so that jaws 118 and 120 grasp paper tape 104 therebetween. Carriage 142 of conveyer 112 continues to move, pulling paper tape 104 against tear-off edge 108, as shown in FIG. 6, to sever paper tape 104. Since carriage 142 moves along axis 114, printer 102 is located at angle 126 with respect to axis 114, and jaws 118 and 120 are approximately parallel to tear-off edge 108, carriage 142 pulls paper tape 108 at angle 126 with respect to tear-off edge 108. This facilitates severing paper tape 108.

After paper tape 108 is severed, grasper 110 continues to grasp a segment 166 of paper tape 108, and carriage 142 of conveyer 112 continues to move in the direction of arrow 170, as shown in FIG. 3. At time t3 of the timing sequence, controller 116 transmits a signal c3 to electromechanical valve 136 via cable 140 instructing electromechanical valve 136 to allow fluid to flow from the fluid supply to actuator 122 via fluid-flow line 138, electromechanical valve 136, and fluid-flow line 134. This causes slide 130 of actuator 122 to move jaw 118 along axis 124 and out of engagement with paper tape 104 to release segment 166 of paper tape 108 from between jaws 118 and 120.

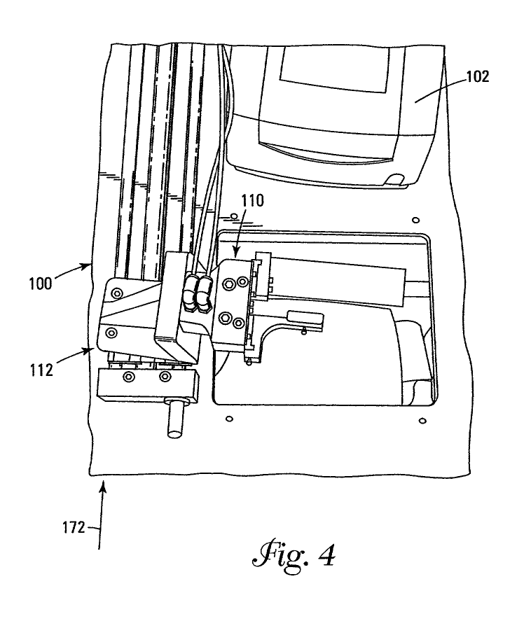

At time t4 of the timing sequence, controller 116 transmits a signal c4 to electromechanical valve 158 instructing electromechanical valve 158 to allow fluid to flow from the fluid supply to conveyer 112 via fluid-flow line 160, electromechanical valve 158, and fluid-flow line 156. This causes carriage 142 to move grasper 110 in the direction of arrow 172 in FIG. 4 to return grasper 110 from the position of FIG. 4 to the position of FIG. 1.

### Conclusion

Embodiments of the present invention have been described. The embodiments provide tearing tools for automatically tearing a tearable medium, such as paper tape 104. The tearing tools provided facilitate a reduction in cost associated with testing for printer tear-off edge wear and generation of particles of the tearable medium caused by tearing the tearable medium at the tear-off edge by eliminating hand tearing of the tearable medium during testing.

Although specific embodiments have been illustrated and described in this specification, it will be appreciated by those of ordinary skill in the art that any arrangement that is calculated to achieve the same purpose may be substituted for the specific embodiment shown. This application is intended to cover any adaptations or variations of the present invention. For example, sensors, e.g., optical, electromechanical, or the like, may be distributed along conveyer 112 for respectively transmitting signals c1-c4 to controller 116 that are respectively indicative of instantaneous positions of carriage 142.

What is claimed is:

1. A tool comprising:
a grasper adapted to selectively grasp a tearable medium;
a conveyer adapted to selectively move the grasper along an axis to move the tearable medium against a tear-off edge to sever the tearable medium; and
a controller adapted to transmit a first signal for instructing the conveyer to move the grasper and a second signal for instructing the grasper to grasp the tearable medium.

2. The tool of claim 1, wherein the grasper comprises first and second jaws adapted to grasp the tearable medium therebetween.

3. The tool of claim 2, wherein the first jaw comprises a pad for frictionally engaging the tearable medium.

4. The tool of claim 1, wherein the controller comprises a programmable logic device.

5. The tool of claim 2, wherein the grasper comprises an actuator adapted to move the first jaw into engagement with the tearable medium for grasping the tearable medium between the first and second jaws and to move the first jaw out of engagement with the tearable medium for releasing the tearable medium from between the first and second jaws.

6. The tool of claim 1, wherein the tear-off edge constitutes a part of a printer.

7. The tool of claim 2, wherein the first jaw is actuatable along an axis that forms an angle with the axis along which the conveyer moves the grasper.

8. The tool of claim 1, wherein the controller receives a signal that instructs the controller to transmit the first and second signals.

9. The tool of claim 1, and further comprising an electromechanical valve that receives the first signal from the controller, the electromechanical valve passing a flow of fluid to the conveyer upon receiving the first signal for moving the grasper.

10. The tool of claim 2, and further comprising an electromechanical valve that receives the second signal, the electromechanical valve passing a flow of fluid to the grasper upon receiving the second signal for moving the first jaw into engagement with the tearable medium.

11. The tool of claim 1, wherein the conveyer comprises a carriage and at least one rail, the carriage slidably attached to the at least one rail and fixedly attached to the grasper.

12. A tool comprising:
first and second jaws;
an actuator adapted to selectively move the first jaw along a first axis into engagement with a tearable medium to grasp the tearable medium between the first and second jaws and out of engagement with the tearable medium to release the tearable medium from between the first and second jaws;
a conveyer adapted to selectively move the first and second jaws along a second axis that forms an angle with the first axis to move the tearable medium when grasped by the first and second jaws against a tear-off edge to sever the tearable medium; and
a controller adapted to transmit a first signal for instructing the conveyer to move the grasper from a first position, and a second signal for instructing the actuator to move the first jaw into engagement with the tearable medium.

13. A method for severing a tearable medium, the method comprising:
receiving the tearable medium between a first jaw and a second jaw of a grasper;
receiving a signal at a controller, the signal instructing the controller to transmit a sequence of signals;
instructing a conveyer to move the grasper from a first position using a first signal of the sequence of signals;
instructing the grasper to grasp the tearable medium between the first and second jaws using a second signal of the sequence of signals; and
pulling the tearable medium, when grasped between the first and second jaws, against a tear-off edge using the conveyer.

14. The method of claim 13, and further comprising instructing the grasper to release the tearable medium from between the first and second jaws using a third signal of the sequence of signals.

15. The method of claim 14, and further comprising instructing the conveyer to return the grasper to the first position using a fourth signal of the sequence of signals.

16. The method of claim 13, wherein instructing the conveyer to move the grasper comprises transmitting the first signal of the sequence of signals to an electromechanical valve, the electromechanical valve passing a flow of fluid to the conveyer upon receiving the first signal of the sequence of signals for moving the grasper.

17. The method of claim 13, wherein instructing the grasper to grasp the tearable medium comprises transmitting the second signal of the sequence of signals to an electromechanical valve, the electromechanical valve passing a flow of fluid to the grasper upon receiving the second signal of the sequence of signals for moving the first jaw into engagement with the tearable medium.

18. The method of claim 13, wherein pulling the tearable medium against the tear-off edge occurs at an angle.

19. The method of claim 13, wherein receiving the tearable medium comprises receiving a paper tape from a printer.

20. The method of claim 13, and further comprising transmitting each of the sequence of signals from the controller at each of a sequence of times preprogrammed into the controller.

21. A tool for tearing printable media from an imaging device, the tool comprising:
a conveyer;
an actuator attached to the conveyer, the actuator comprising a slide;
a first jaw attached to the slide of the actuator;
a second jaw fixedly attached to the actuator and located opposite the first jaw; and
a controller connected to the conveyer and the actuator.

22. The tool of claim 21, wherein the first jaw comprises a pad.

23. The tool of claim 21, wherein the controller comprises a programmable logic device.

24. The tool of claim 21, and further comprising an electromechanical valve that is electrically connected to the controller and fluidly connected to the conveyer.

25. The tool of claim 21, and further comprising an electromechanical valve that is electrically connected to the controller and fluidly connected to the actuator.

26. The tool of claim 21, wherein the conveyer comprises a carriage and at least one rail, the carriage slidably attached to at least one rail and fixedly attached to the actuator.

27. The tool of claim 21, wherein the actuator is attached to the conveyer so that the slide of the actuator is oriented at an angle with respect to the conveyer.
